(19) United States
(12) Patent Application Publication
(10) Pub. No.: US 2016/0257529 A1
(43) Pub. Date: Sep. 8, 2016

(54) ELEVATOR DRIVE

(71) Applicant: INVENTIO AG, Hergiswil (CH)

(72) Inventor: Josef Husmann, Luzern (CH)

(21) Appl. No.: 15/033,179

(22) PCT Filed: Nov. 13, 2014
(86) PCT No.: PCT/EP2014/074547

§ 371 Date: Apr. 29, 2016

(30) Foreign Application Priority Data
Nov. 14, 2013 (EP) 13192842.6

(51) Int. Cl. B66B 11/08; B66B 11/00; B66B 9/00

(52) U.S. Cl. CPC B66B 11/08; B66B 9/00; B66B 11/007; B66B 11/06

(57) ABSTRACT

An elevator drive for use in a counterweight-less elevator installation includes a motor driving a traction sheave in engagement with an elongate load bearing member supporting an elevator car, and a pressure applicator exerting a normal force on the elongate load bearing member as the member engages with the traction sheave. One of the traction sheave and the pressure applicator is displaceable relative to the other. Accordingly, in use, the normal force imparted by the pressure applicator on the elongate load bearing member can be varied to improve the longevity of the elongate load bearing member.

### FIELD

The present disclosure relates to an elevator drive. The elevator drive is particularly beneficial when incorporated into a counterweight-less elevator installation.

### BACKGROUND

In the majority of new buildings, the elevator is designed as a traction elevator where a car and a counterweight are interconnected by a rope or a belt which passes over a motor driven traction sheave to effect vertical travel of the interconnected car and counterweight along guide rails installed throughout a hoistway. However, there are occasions when the available space in a building is insufficient to accommodate a conventional traction elevator with a counterweight. Examples of such occasions include the modernization of an existing installation having a narrow hoistway or retrofitting a new elevator installation within an existing stairwell of a building where space is limited.

EP-A1-1947048 and US-2009/0321191 both describe counterweight-less elevator systems using a tensioned toothed or cog belt circumscribing a closed loop or path from the top of the elevator car over multiple pulleys mounted in the top and bottom of the hoistway and back to the bottom of the elevator car. A motor driven toothed pulley is provided alongside and in engagement with the tensioned toothed belt to achieve a positive drive therebetween to raise and lower the elevator car along guide rails within the hoistway. The toothed belt and the associated drive are expensive and the intermeshing of the teeth of the belt with those of the drive can cause considerable noise during operation.

A similar closed-loop, counterweight-less elevator system is described in WO-A1-2004/041704. However, rather than using a positive drive and a toothed belt to transmit lifting force to the elevator car, traction is used to raise and lower the elevator car within the hoistway. Since no counterweight is employed to compensate for, or partially balance, the forces imposed by the elevator car (i.e. the weight of the car and the load therein), the hoisting machine must develop sufficient torque to not only drive the loaded car but also fully support the loaded car. Rather than use a larger traction machine to deliver the substantially greater torque required as compared to a conventional traction elevator with a counterweight, the elevator installation of WO-A1-2004/041704 adopts a different solution where the suspension or roping ratios are increased from the common 1:1 or 2:1 arrangements to complex arrangements where the roping ratio varies between 4:1 (wherein a 4 m movement of the hoisting ropes by the traction sheave results in a 1 m movement of the elevator car) to 10:1 (wherein a 10 m movement of the hoisting ropes by the traction sheave results in a 1 m movement of the elevator car). Similar closed-loop arrangements are described in FR-A1-2925885 and WO-A1-2011/107152.

For all of the above described systems, the closed-loop whether in the form of a toothed belt or a conventional rope, is subjected to substantial tension at all times. Considerable reaction forces are transmitted to the hoistway structure not only from the drive but from each deflection pulley defining the path of the closed-loop. Accordingly, the building structure must be capable of withstanding these additional loads within the hoistway.

Furthermore, in comparison with a conventional traction elevator with counterweight, even the simplest closed-loop system requires a belt or rope which is at least twice as long and there are at least twice as many bends in its travel path. This adds to the expensive not only with regard to initial capital expenditure in respect of the belts/ropes and the deflecting pulleys but also in relation to the increased installation time and on-going maintenance costs. Moreover, increasing the number of bends in the travel path of the belt/rope generally reduces its lifespan. These problems are further exaggerated for the complex roping arrangements outlined in WO-A1-2004/041704.

Conventional rope winch or rope drum elevators without counterweights have been installed in the past wherein one end of the rope is attached to a drum while the other end of the rope supports the elevator car. The drum is rotationally driven so that the rope can be either successively wrapped upon the drum to raise the elevator car, or successively unwrapped from the drum to lower the elevator car. For safety reasons, a gear or transmission is generally required between the motor and the drum in these installations to prevent the inadvertent unwrapping of the rope from the drum in the event of power loss to the motor.

An alternative arrangement is the self-propelled elevator system of US-2003/0051948 in which a motor driven traction sheave is mounted to the elevator car and engages with a belt suspended from the ceiling of the hoistway. A plurality of rolling members partially encircles the traction sheave and the belt is received between the rolling members and the traction sheave. The axes of the rolling members remain stationary relative to the axis of the traction sheave. The rolling members continuously apply a normal force to bias the belt into engagement with the traction sheave. In order to avoid any slippage of the belt through the drive, a minimum urging or normal force of the rollers must be preset so as to accommodate for the absolute maximum load exerted through the elevator car during operation. Typically this maximum load Fₘₐₓ exerted by the car can be expressed by the following equation: Fₘₐₓ=((m_{c}+(mₗ*s))*(a+g) where m_{c} is the mass of the empty car itself, mₗ is the rated load of the elevator, s is a relevant safety factor, a is the rated acceleration of the elevator and g is gravitational acceleration.

Inherently, during operation, the actual load exerted through the car will rarely, if ever, reach the maximum load level Fₘₐₓ. Accordingly, the preset minimum urging or normal force of the rollers is excessive in normal operating conditions. This leads to early deterioration of the belts.

U.S. Pat. No. 4,620,615 discloses a similar system but for use in conventional traction elevators employing counterweights. A plurality of rollers is biased by a tension spring into engagement with the ropes as they pass over the traction sheave. The force of the tension spring can be adjusted by a jacking bolt.

### SUMMARY

The invention provides an elevator drive, comprising a motor, a traction sheave driven by the motor whereby the traction sheave is arranged for engagement with an elongate load bearing member supporting an elevator car, pressure means or applicator arranged to exert normal force towards the traction sheave wherein one of the traction sheave and the pressure means is displaceable relative to the other. One of the traction sheave and the pressure means is mounted on a lever rotatable about a fulcrum. With this arrangement, a tension in the elongate load bearing member can be used to bias the lever about the fulcrum. Accordingly, the normal force exerted by the pressure means on the elongate load bearing member as it engages with the traction sheave can be varied in accordance with changes in the tension of the elongate load bearing member. This can improve the longevity of the elongate load bearing member.

Advantageously, the elevator drive further comprises a switch to monitor a position of the lever. Consequently, if the pressure means fails resulting in the lever moving to the monitored position, an output from the switch can be used to automatically de-energize the drive, close one or more brakes, activate safety gears, and/or signal the fault to an elevator controller or a remote monitoring center so that any passengers trapped in the elevator car can be evacuated and the required maintenance can be carried out.

In one embodiment the pressure means comprises a belt entrained over a first pulley and a second pulley so that the belt can move concurrently with the elongate load bearing member. Accordingly the belt, in the section between the first and second pulleys, can exert a normal force on the elongate load bearing member as it passes over an arcuate section of the traction sheave. With this arrangement, since one of the traction sheave and the pressure means is displaceable relative to the other, not only can the normal force exerted by the pressure means be varied but also an angle defining the arcuate section with which it engages with the elongate load bearing member as it passes over the traction sheave can also be changed.

Alternatively, the pressure means or applicator may comprise a series of rollers spring biased towards the traction sheave.

In one embodiment the motor is mounted on a lever rotatable about a fulcrum. Here the gravitational force acting on the motor can be used to bias the motor and the traction sheave about the fulcrum so as to clamp the elongate load bearing member between the traction sheave and the pressure means. As previously explained, the tension in the load bearing member can be used to additionally bias the traction sheave towards the pressure means.

In another example the pressure means is mounted on a lever rotatable about a fulcrum. The tension in the load bearing member can be used to bias the pressure means about the fulcrum towards the traction sheave. Preferably the elevator drive further includes a spring to bias the pressure means towards the traction sheave. Accordingly, if the elongate load bearing member becomes slack, which can happen for example when any car mounted safety gears or brakes are active to hold the elevator, there is zero tension in the elongate load bearing member and consequently there is no bias provided to the lever by the elongate load bearing member. In this case a spring bias provided by a pre-tensioned spring is adequate to ensure that there is sufficient pressure exerted on the elongate load bearing member by the pressure means to enable the elevator drive to take up the slack in the elongate load bearing member and commence normal operation.

Preferably, the elevator drive further includes a diverting pulley mounted to the lever wherein, in use, the elongate load bearing member travels over the diverting pulley. In use, with the elongate load bearing member traveling over the diverting pulley, the tension in the load bearing member can be used to bias the pressure means about the fulcrum towards the traction sheave.

Preferably, the pressure means comprises a belt entrained over a first pulley and a second pulley and wherein at least one of the first pulley and the second pulley is mounted on the lever. Accordingly, movement of the lever will result in displacement of the belt relative to the traction sheave.

The elevator drive can be used in an elevator installation and preferably a counterweight-less elevator installation wherein an elevator car is interconnected by the elongate load bearing member to the drive so that the drive is employed to draw in or, alternatively, feed out the elongate load bearing member to effect vertical travel of the elevator car along guide rails within a hoistway.

The elongate load bearing member may be a conventional elevator rope, a flat belt or a ribbed belt or any other component which is suitable for engagement with the traction sheave and for supporting an elevator car.

### DESCRIPTION OF THE DRAWINGS

The disclosure refers to the following figures:

FIG. 1 is a schematic plan view of an elevator drive according to a first embodiment of the present disclosure;

FIG. 2 is a further schematic plan view of the elevator drive of FIG. 1;

FIGS. 3A-3D show typical arrangements of an elevator drive within an elevator hoistway;

FIG. 4 shows a perspective view of an exemplary embodiment of an elevator drive mounted within an elevator hoistway;

FIG. 5 is a partial, perspective view of the drive of FIG. 4 with the support enclosure removed;

FIG. 6 is a schematic plan view of a further elevator drive according to an embodiment of the present disclosure;

FIG. 7 is a further schematic plan view of the elevator drive of FIG. 6;

FIG. 8 is a schematic plan view of a further elevator drive according to an embodiment of the present disclosure;

FIG. 9 is a further schematic plan view of the elevator drive of FIG. 6;

FIG. 10 shows a typical arrangement of the pressure belt as used in the elevator drives illustrated in the previous figures;

FIG. 11 illustrates an alternative arrangement of the pressure belt of FIG. 10;

FIG. 12 shows a different arrangement for applying pressure to the traction sheave of elevator drives illustrated in FIGS. 1 to 11;

FIG. 13 illustrates an alternative arrangement to that depicted in FIG. 12; and

FIG. 14 is a schematic illustrating an elevator installation incorporating an alternative method of storing the elongate load bearing member.

### DETAILED DESCRIPTION

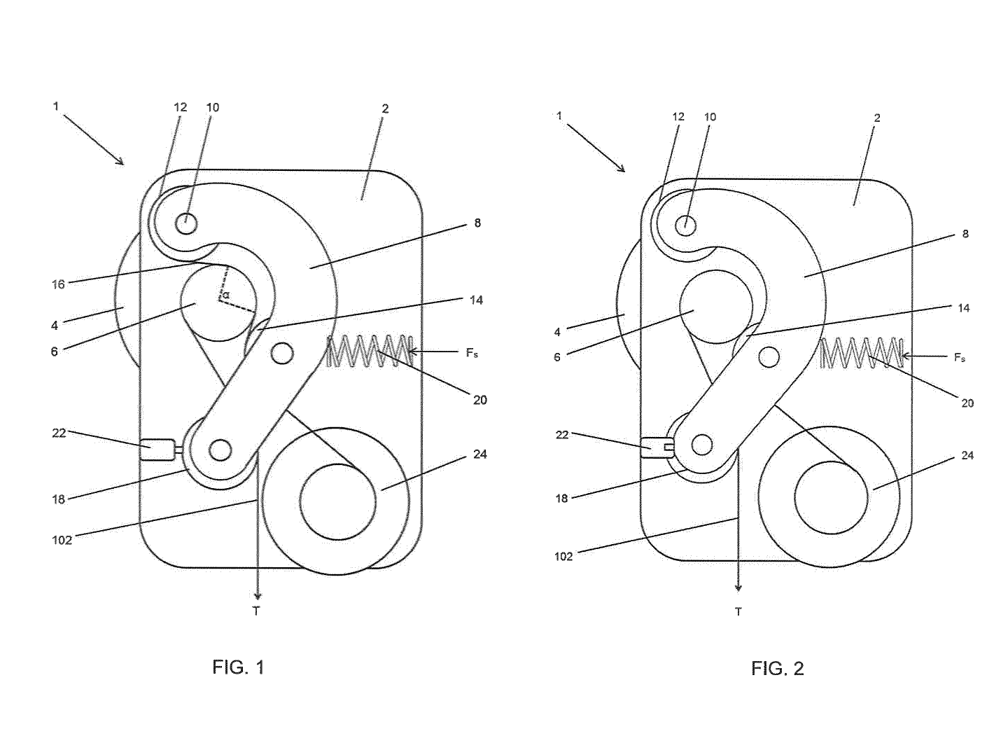

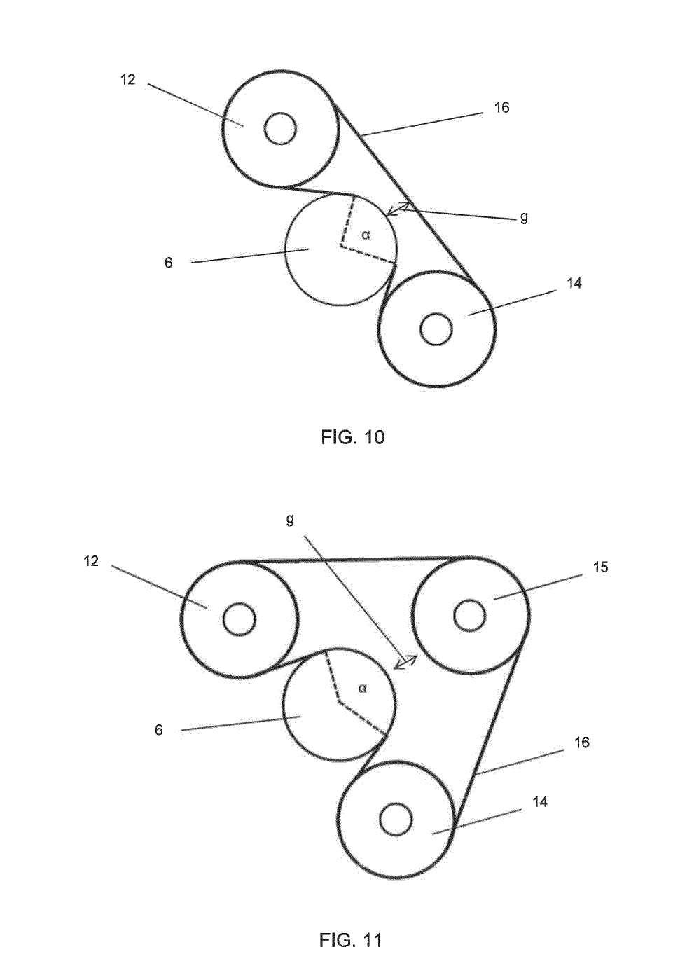

FIG. 1 is a schematic plan view of an elevator drive 1 according to a first embodiment. The drive 1 includes an electric motor 4 mounted to one side of a support frame 2. Preferably, the electric motor is gearless. An output shaft of the motor 4 extends through the support frame 2 to rotate a traction sheave 6 positioned on the other side of the support frame 2. In this particular example the motor shaft itself acts as the traction sheave, but other arrangements are also possible. A clamping lever 8 is pivotally mounted on a fulcrum 10 to the support frame 2. The clamping lever 8 accommodates a first pressure pulley 12 that is mounted concentrically within the fulcrum 10, a second pressure pulley 14 that is disposed at an intermediate position along the lever 8, and a diverting pulley 18 at an end of the lever 8 that is remote from the fulcrum 10. A pressure belt 16 is entrained over the first and second pressure pulleys 12 and 14. A more detailed illustration of the path of the pressure belt 16 is given in FIG. 10.

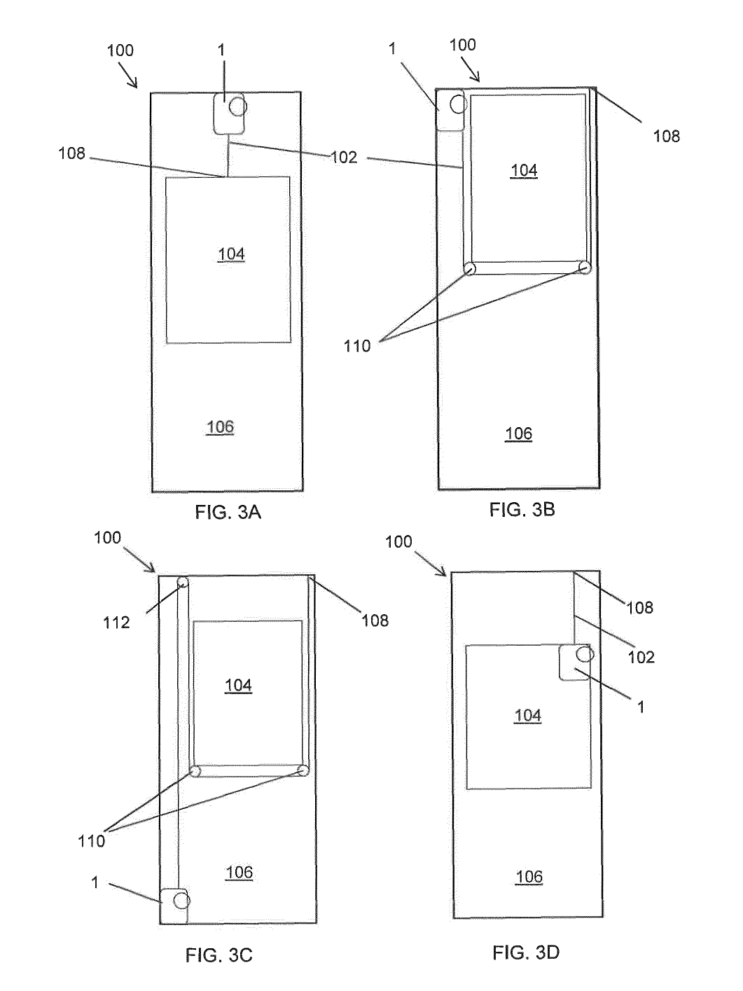

An elongate load bearing member 102 which supports an elevator car 104 (as shown in FIGS. 3A-3D) passes over the diverting pulley 18, around the traction sheave 6, over the second pressure pulley 14 to be wound onto and unwound from a reel 24. In this example the elongate load bearing member 102 is a flat belt.

The pressure belt 16 moves concurrently with the elongate load bearing member 102 and applies a clamping or normal force on the elongate load bearing member 102 as it passes over an arcuate section of the traction sheave 6 defined by an angle α. The normal force is directed toward the center of the traction sheave 6.

The reel 24 can be driven by an auxiliary motor or synchronized with the electric motor 4.

In operation, through its interaction with the diverting pulley 18, a tension T in the elongate load bearing member 102 biases the clamping lever 8 clockwise about the fulcrum 10. This in turn results in a specific clamping force being exerted by the pressure belt 16 on the elongate load bearing member 102 as it passes over the traction sheave 6. If the tension T in the elongate load bearing member 102 increases, the clamping lever 8 moves further clockwise about the fulcrum 10 resulting in a greater clamping force being exerted by the pressure belt 16 on the elongate load bearing member 102 as it passes over the traction sheave 6. Additionally, the angle α through which the pressure belt 16 applies the normal, clamping force on the elongate load bearing member 102 as it passes over the traction sheave 6 also increases and thereby aids in improving the traction.

On the contrary, if the tension T in the elongate load bearing member 102 decreases, the clamping lever 8 moves counterclockwise about the fulcrum 10 and the clamping force exerted by the pressure belt 16 on the elongate load bearing member 102 reduces together with the angle α through which the pressure belt 16 interacts with the elongate load bearing member 102.

If the elongate load bearing member 102 becomes slack, which can happen for example when any car mounted safety gears or brakes are active to hold the elevator, there is zero tension T in the elongate load bearing member 102 and consequently there is no clockwise bias provided to the lever 8 by the elongate load bearing member 102. In this case a spring bias Fₛ provided by a pre-tensioned spring 20 is adequate to ensure that there is sufficient pressure exerted on the elongate load bearing member 102 by the pressure belt 16 to enable the elevator drive 1 to take up the slack in the elongate load bearing member 102 and commence normal operation.

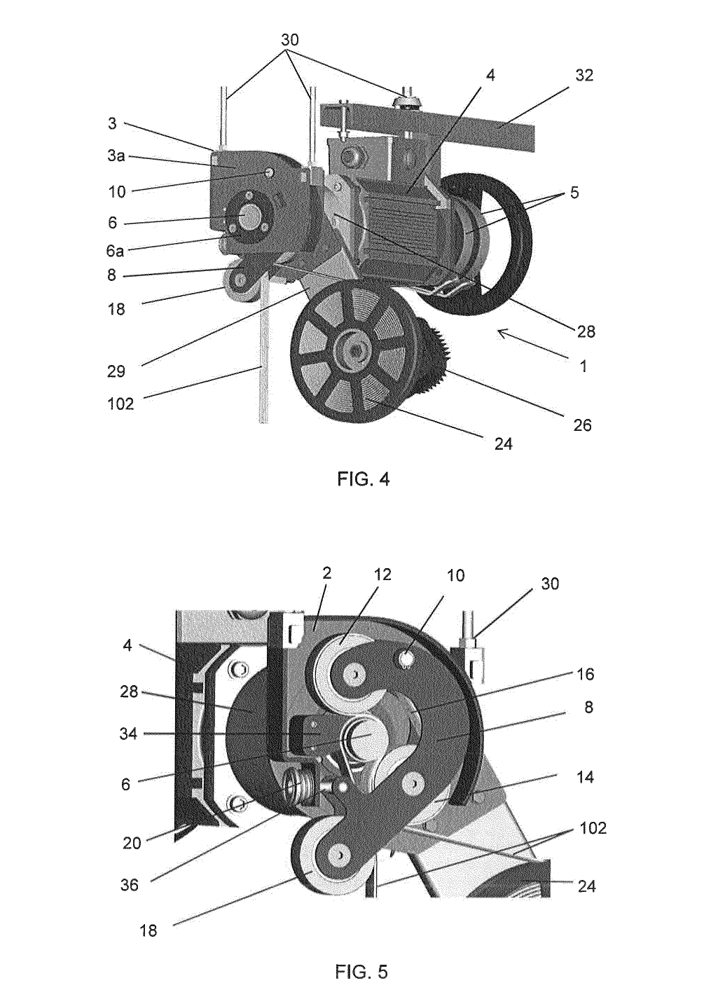

During operation there are considerable loads imposed on the pressure belt 16. If the pressure belt 16 fails, it can no longer provide any resistance to the clockwise bias of the lever 8 about the fulcrum 10 provided by the spring bias Fₛ and/or the bias provided by the elongate load bearing member 102 as it runs over the diverting pulley 18. Accordingly, the lever 8 will rotate to an extreme clockwise position, as shown in FIG. 2 such that the elongate load bearing member 102 is directly clamped between the traction sheave 6 and the second pressure pulley 14 and the elongate load bearing member 102 is immobilized. In this position, the lever 8 also activates a safety switch 22 which automatically switches off the drive 1 and closes a motor brake 5 (shown in FIG. 4).

FIGS. 3A to 3D show typical arrangements of exemplary elevator installations 100 incorporating elevator drives 1 according to the present disclosure. In all of the illustrated elevator installations 100, an elevator car 104 is interconnected by the elongate load bearing member 102 to the drive 1. As previously described, the drive 1 is employed to draw in or, alternatively, feed out the elongate load bearing member 102 to effect vertical travel of the elevator car 104 along guide rails (not show) within a hoistway 106.

In the example depicted in FIG. 3A the drive 1 is mounted to a ceiling of the hoistway 106. The elongate load bearing member 102 extends downwards from the drive 1 and is fastened at a termination 108 to the top of the elevator car 104. In this typical 1:1 roping arrangement, the length of the elongate load bearing member 102 drawn into or fed out from the drive 1 results in a corresponding amount of vertical travel of the car 104 within the hoistway 106.

An alternative 2:1 roping arrangement is illustrated in FIG. 3B where the drive 1 is again mounted to the ceiling but also close to a side wall of the hoistway 106 so as to not encroach on the travel path of the elevator car 104 as it is raised towards the ceiling of the hoistway 106. The elongate load bearing member 102 extends downwards from the drive 1 around two underslung diverting pulleys 110 arranged beneath the car 104 and further to a termination 108 fixed to the ceiling of the hoistway 106. This particular embodiment employs a 2:1 roping arrangement whereby every unit of length of elongate load bearing member 102 drawn into or fed out from the drive 1 results in half the corresponding amount of vertical travel of the car 104 within the hoistway 106.

In contrast to the arrangement of FIG. 3B, the drive 1 can be mounted in a pit of the hoistway 106 as shown in FIG. 3C. In this embodiment, the elongate load bearing member 102 extends upwards from the drive 1 over a ceiling mounted diverting pulley 112, around two underslung diverting pulleys 110 arranged beneath the car 104 and further to a termination 108 fixed to the ceiling of the hoistway 106.

Instead of mounting the diverting pulleys 110 in an underslung arrangement as shown in FIGS. 3B and 3C, the diverting pulleys 110 can be mounted above the car 104 in an overslung arrangement.

FIG. 3D depicts an arrangement similar to that of FIG. 3A except the respective mounting positions of the drive 1 and the termination 108 of the elongate load bearing member 102 have been exchanged. In this embodiment, the drive 1 is mounted on the car while the termination 108 is mounted to the ceiling of the elevator hoistway 106.

It will be appreciated that these particular examples do not form an exhaustive list of all possible arrangements, but that many different drive orientations and positions as well as different roping arrangements are also feasible in the context of the present disclosure.

FIG. 4 shows a perspective view of an exemplary embodiment of an elevator drive 1 arranged at the top of an elevator hoistway 106. The electric motor 4 is mounted via one or more bolts 30 to a structural support beam 32 provided in the top of the hoistway (not shown). In this example, the motor 4 is provided with two disc brakes 5. Rather than being directly coupled to the traction sheave 6 as in the previous examples, a conventional flexible coupler 28, such as that described in U.S. Pat. No. 6,315,080, interconnects the shaft of the motor 4 to the traction sheave 6. The flexible coupler 28 allows for slight misalignment in the position of the sheave 6 relative to the motor shaft while ensuring that the full torque developed by the motor 4 is still transmitted to the traction sheave 6 during operation.

The support frame 2 is surrounded by an enclosure 3 to protect the components of the drive 1 housed within. Additionally, a faceplate 3a of the enclosure 3 is provided with a bearing 6a to rotatably support the traction sheave 6 at an axial end remote from the support frame 2. Similarly, the faceplate 3a also supports an end of the fulcrum 10 about which the clamping lever 8 pivots. The support frame 2 and its enclosure 3 are fixed to the ceiling of the elevator hoistway by bolts 30. In this example the reel 24 from which the elongate load bearing member 102 is wound and unwound is driven by an auxiliary motor 26 both of which are mounted to the support frame 2 by a bracket 29.

FIG. 5 is a partial, perspective view of the drive of FIG. 4 with the faceplate 3a on the support frame enclosure 3 removed. While the drive 1 in both its construction and operation corresponds closely to that as described with reference to FIGS. 1 and 2, there are differences in this embodiment which require further explanation.

The clamping lever 8 is formed from two interconnected J-shaped plates. The J-shaped plates provide axial support at both ends of the first pressure pulley 12, the second pressure pulley 14 and the diverting pulley 18.

Another notable difference is that the fulcrum 10 about which the clamping lever 8 rotates is no longer concentric with the first pressure pulley 12 but instead is located at an intermediate position along the clamping lever 8 between the first and second pressure pulleys 12 and 14.

As previously discussed, the tension T in the elongate load bearing member 102, through its interaction with the diverting pulley 18, biases the clamping lever 8 clockwise about the fulcrum 10. This in turn results in a specific clamping force exerted by the pressure belt 16 on the elongate load bearing member 102 as it passes over the traction sheave 6. It also results in a specific angle α through which the pressure belt 16 applies the normal, clamping force on the elongate load bearing member 102 as it passes over the traction sheave 6. Accordingly, the position of the fulcrum 10 is of critical importance as it determines the degree to which an increase/decrease in the tension T of the elongate load bearing member 102 varies a) the normal, clamping force exerted by the pressure belt 16 on the elongate load bearing member 102 as it passes over the traction sheave 6 and/or b) the angle α through which the pressure belt 16 engages with the elongate load bearing member 102 as it passes over the traction sheave 6. The flexibility in choosing the position of the fulcrum 10 thereby enables the engineer to tailor solutions for different specific elevator designs, roping arrangements, rated loads, rated speeds and types of elongate load bearing members 102.

In this particular example, a guide 34 is mounted to the support frame 2 to help technicians to correctly and easily feed the elongate load bearing member 102 into engagement between the traction sheave 6 and the pressure belt 16 upon initial installation. Afterwards, a gap between the installation guide 34 and the elongate load bearing member 102 ensures that the installation guide 34 does not interfere with the elongate load bearing member 102 as it passes over the traction sheave 6 during normal operation of the elevator.

The pre-tensioned spring 20 in this embodiment is positioned between a face of a plunger 36 and the support frame enclosure 3. An end of the plunger 36 remote from the face is pivoted to the clamping lever 8. As in the previously described examples, the pre-tensioned spring 20 provides a spring force to bias the clamping lever 8 clockwise about its fulcrum 10. In the event that the elongate load bearing member 102 becomes slack, the spring bias of a pre-tensioned spring 20 is adequate to ensure that there is sufficient pressure exerted on the elongate load bearing member 102 by the pressure belt 16 to enable the elevator drive 1 to take up the slack in the elongate load bearing member 102 and commence normal operation.

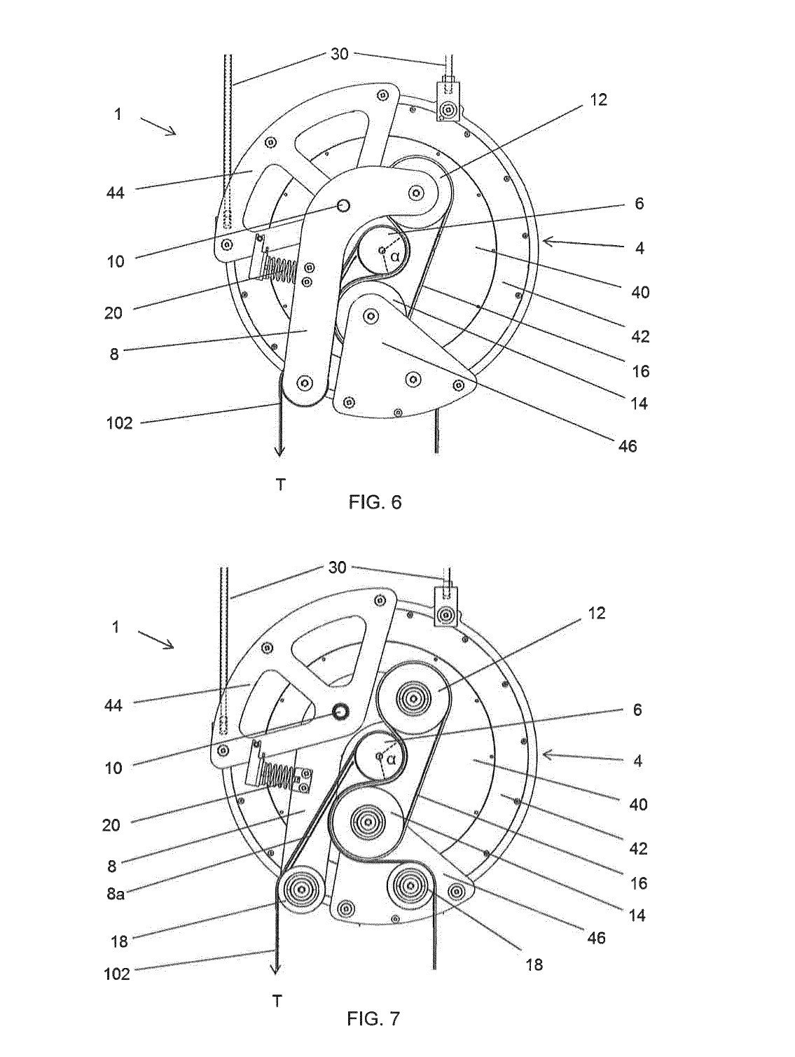

FIG. 6 is a schematic plan view of an elevator drive 1 according to another embodiment. In contrast to the examples depicted in FIGS. 4 and 5, the electric motor 4 of this embodiment is relatively flat a so called disc motor. It includes a housing 42 for stator coils which surround a central rotor 40. Preferably, permanent magnets are mounted to or within the outer circumference of the rotor 40. The rotor 40 rotates a traction sheave 6. A clamping lever 8 is pivotally mounted on a fulcrum 10 which is supported on a bracket 44 fixed to the housing 42 of the motor 4. At one end, the clamping lever 8 accommodates a first pressure pulley 12 and at the opposing end it accommodates a diverting pulley 18. The clamping lever 8 is formed from two interconnected J-shaped plates. The J-shaped plates provide axial support at both ends of the first pressure pulley 12 and the diverting pulley 18. A pre-tensioned spring 20 biases the lever 8 counterclockwise about the fulcrum 10.

In this embodiment, a second pressure pulley 14 is provided but instead of being mounted to the clamping lever 8 as in the previously described examples, it is pivotally mounted to a bracket 46 secured to the housing 42 of the motor 4. Again a pressure belt 16 is entrained over the first and second pressure pulleys 12 and 14.

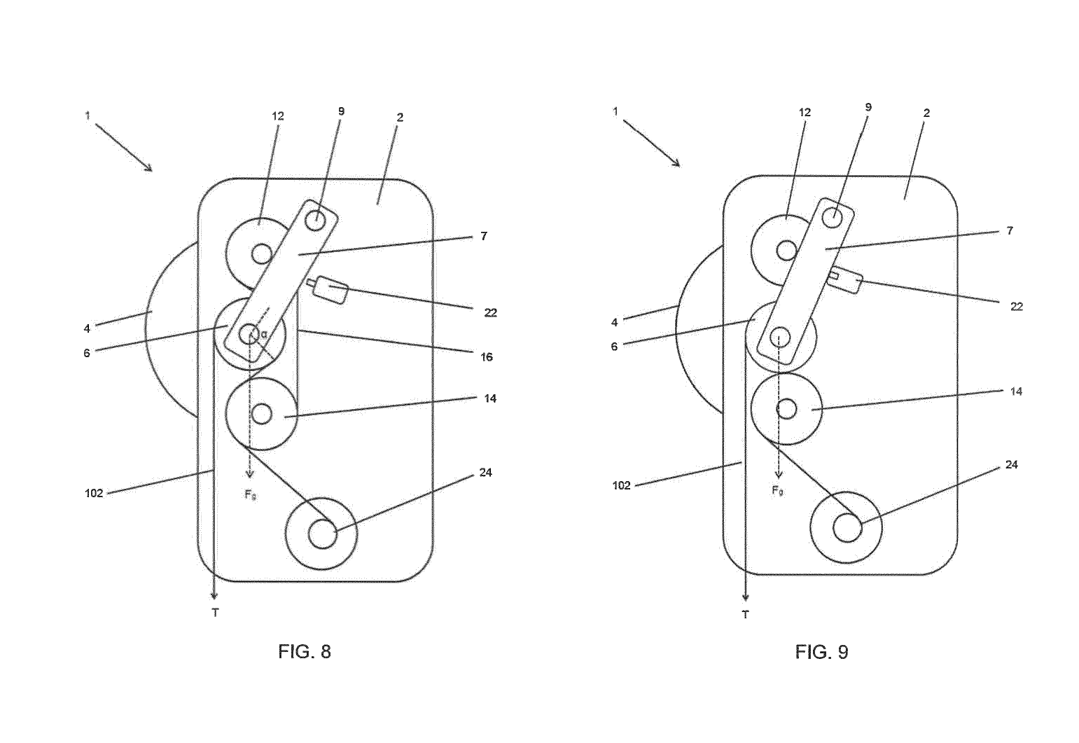

FIG. 7 is a schematic plan view of the elevator drive 1 shown in FIG. 6 however the outer J-shaped plate has been removed to better illustrate the path taken by the elongate load bearing member 102 as it is drawn into and fed from the drive 1. As previously discussed, the elongate load bearing member 102 supports an elevator car 104 (as illustrated in FIGS. 3A-3D). It passes over the diverting pulley 18 at one end of the clamping lever 8, around the traction sheave 6, over the second pressure pulley 14 and around a further diverting pulley 18 mounted to the bracket 46. A divider 8a is mounted between the J-shaped plates of the lever 8 and is aligned in parallel to the path of the elongate load bearing member 102 as it moves between the diverting pulley 18 and the traction sheave 6. The divider 8a ensures that there is no interference or engagement between the tensioned portion of the elongate load bearing member 102 on one side of the traction sheave 6 and the essentially untensioned portion of the elongate load bearing member 102 on the other side of the traction sheave 6 that passes over the second pressure pulley 14.

The pressure belt 16 moves concurrently with the elongate load bearing member 102 and applies a clamping or normal force on the elongate load bearing member 102 as it passes over an arcuate section the traction sheave 6 defined by an angle α. The normal force is directed toward the center of the traction sheave 6.

In operation, through its interaction with the diverting pulley 18, a tension T in the elongate load bearing member 102 biases the clamping lever 8, and thereby the first pressure pulley 12, counterclockwise about the fulcrum 10. This in turn results in a specific clamping force being exerted by the pressure belt 16 on the elongate load bearing member 102 as it passes over the traction sheave 6. If the tension T in the elongate load bearing member 102 increases, the clamping lever 8 and the first pressure pulley 12 move further counterclockwise about the fulcrum 10 resulting in a greater clamping force being exerted by the pressure belt 16 on the elongate load bearing member 102 as it passes over the traction sheave 6. Additionally, the angle α through which the pressure belt 16 applies the normal, clamping force on the elongate load bearing member 102 as it passes over the traction sheave 6 also increases and thereby aids in improving the traction.

On the contrary, if the tension T in the elongate load bearing member 102 decreases, the clamping lever 8 and first pressure pulley 12 move clockwise about the fulcrum 10 and the clamping force exerted by the pressure belt 16 on the elongate load bearing member 102 reduces together with the angle α through which the pressure belt 16 interacts with the elongate load bearing member 102.

If the elongate load bearing member 102 becomes slack, which can happen for example when any car mounted safety gears or brakes are active to hold the elevator, there is zero tension T in the elongate load bearing member 102 and consequently there is no counterclockwise bias provided to the lever 8 by the elongate load bearing member 102. In this case a spring bias provided by a pre-tensioned spring 20 is adequate to ensure that there is sufficient pressure exerted on the elongate load bearing member 102 by the pressure belt 16 to enable the elevator drive 1 to take up the slack in the elongate load bearing member 102 and commence normal operation.

FIG. 8 is a schematic plan view of an elevator drive 1 according to another embodiment. In this variant each end of the gearless electric motor 4 is carried on a lever 7 pivotally mounted to a fulcrum 9 provided on the support frame 2. The first pressure pulley 12 and the second pressure pulley 14 are rotatably mounted to the support frame 2 and the pressure belt 16 is entrained over the first and second pressure pulleys 12 and 14. In this embodiment, the gravitational force F_{g} acting on the mass of the motor 4 is used to bias the motor 4 and the traction sheave 6 counterclockwise on the lever 7 about the fulcrum 9 so as to clamp the elongate load bearing member 102 between the traction sheave 6 and the pressure belt 16. As in the previously described examples, the tension T in the load bearing member 102 is used to additionally bias the sheave 6 towards the pressure belt 16.

The elongate load bearing member 102 passes around the traction sheave 6 and over the second pressure pulley 14 to be wound onto and unwound from the reel 24. The pressure belt 16 moves concurrently with the elongate load bearing member 102 and applies a clamping, normal force towards the center of the traction sheave 6 on the elongate load bearing member 102 as it passes over an arcuate section the traction sheave 6 defined by an angle α.

The reel 24 can be driven by an auxiliary motor or synchronized with the electric motor 4.

In operation, through its interaction with the traction sheave 6, the tension T in the elongate load bearing member 102 biases the lever 7 counterclockwise about the fulcrum 9. This in turn results in a specific clamping force exerted by the pressure belt 16 on the elongate load bearing member 102 as it passes over the traction sheave 6. If the tension T in the elongate load bearing member 102 increases, the lever 7 moves further counterclockwise about the fulcrum 9 resulting in a greater clamping force being exerted by the pressure belt 16 on the elongate load bearing member 102 as it passes over the traction sheave 6. Additionally, the angle α through which the pressure belt 16 applies the normal, clamping force on the elongate load bearing member 102 as it passes over the traction sheave 6 also increases and thereby aids in improving the traction.

On the contrary, if the tension T in the elongate load bearing member 102 decreases, the lever 7 moves clockwise and the clamping force exerted by the pressure belt 16 on the elongate load bearing member 102 reduces together with the angle α through which the pressure belt 16 interacts with the elongate load bearing member 102.

If there is zero or negligible tension T in the elongate load bearing member 102, which can happen for example when any car mounted safety gears or brakes are active to hold the elevator car, the elongate load bearing member 102 provides no counterclockwise bias to the lever 7. In this case the gravitational force F_{g} acting on the motor 4 is such to ensure that there is sufficient pressure exerted on the elongate load bearing member 102 by the pressure belt 16 to enable the elevator drive 1 to take up the slack in the elongate load bearing member 102 and commence normal operation.

There are considerable loads on the pressure belt 16. If the pressure belt 16 fails, it can no longer provide any resistance to the counterclockwise bias of the lever 7 about the fulcrum 9 provided by the gravitational bias F_{g} acting on the motor 4 and/or the bias provided by the elongate load bearing member 102 as it runs over the traction sheave 6. Accordingly, the lever 7 will rotate to an extreme counterclockwise position, as shown in FIG. 9 such that the elongate load bearing member 102 is directly clamped between the traction sheave 6 and the second pressure pulley 14. In this position, the lever 7 also activates a safety switch 22 which automatically switches off the drive 1 and closes one or more motor brakes 5.

FIG. 10 shows a typical arrangement of the pressure belt 16 as used in the elevator drives 1 illustrated in the previous figures. For ease of reference, the orientation of the pressure belt 16 in this figure corresponds most closely to the embodiments shown in FIGS. 1, 2, 4 and 5, however it will be easily appreciated that the orientation can be adapted to match any drive application and, in particular, those drives shown in FIGS. 6 to 9.

The pressure belt 16 is entrained over the first and second pressure pulleys 12 and 14 to form a closed-loop. The traction sheave 6 is positioned between the two pressure pulleys 12 and 14 and the pressure belt 16 engages with the elongate load bearing member 102 as it passes over an arcuate section of the traction sheave 6 defined by an angle α. Relative movement or displacement between the traction sheave 6 and at least one of the pressure pulleys 12, 14 results in changes to the clamping, normal force applied by the pressure belt 16 and also results in changes to the angle α through which the pressure belt 16 engages with the elongate load bearing member 102 as it passes over the traction sheave 6. A minimum clearance g must be maintained between the pressure belt 16 as it passes over the traction sheave 6 and the opposing return section of the pressure belt 16 between the first and second pressure pulleys 12 and 14. This minimum clearance g effectively limits the extent to which relative displacement can occur between the traction sheave 6 and at least one of the pressure pulleys 12, 14.

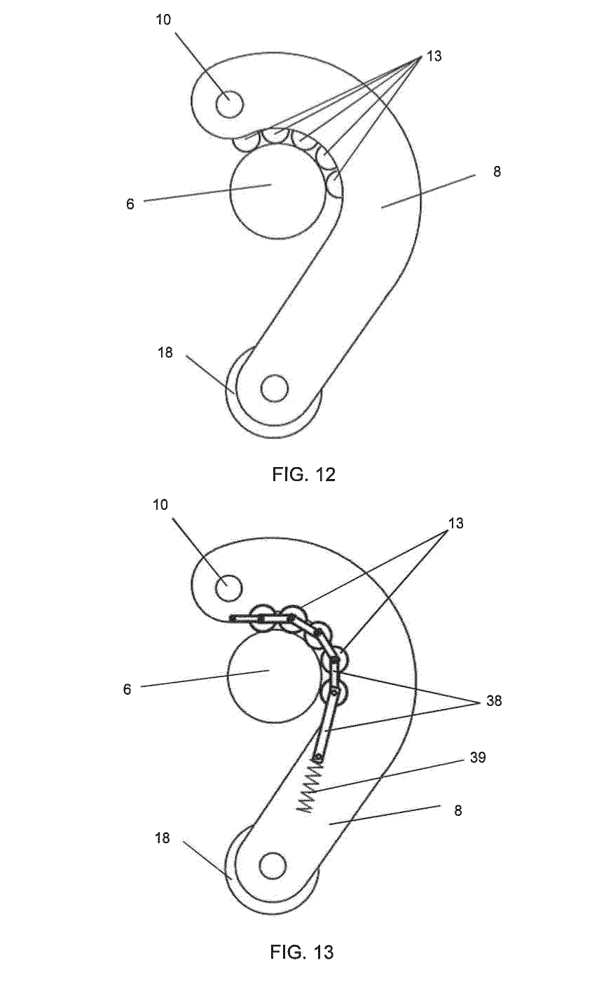

FIG. 11 illustrates an alternative arrangement of the pressure belt 16 of FIG. 10 which gives the designer greater freedom and flexibility in determining the extent to which relative displacement can occur between the traction sheave 6 and at least one of the pressure pulleys 12, 14. In this embodiment, instead of providing a direct return path for the pressure belt 16 between the first and second pressure pulleys 12 and 14, the return path is displaced over a third pressure pulley 15. Accordingly, the angle α through which the pressure belt 16 engages with the elongate load bearing member 102 as it passes over the traction sheave 6 can be increased significantly, while maintaining the minimum clearance g between the pressure belt 16 as it passes over the traction sheave 6 and the third pressure pulley 15.

FIG. 12 shows a different arrangement for applying pressure to the traction sheave 6 of elevator drives previously illustrated and described wherein the pressure belt 16 and associated pressure pulleys 12, 14 have been replaced by roller members 13. In this particular example, the roller members 13 are spring-biased from the clamping lever 8 toward the traction sheave 6. In use, each of the spring-biased roller members 13 exerts a clamping or normal force on the elongate load bearing member 102 as it passes over the traction sheave 6. Any rotation of the clamping lever 8 about its fulcrum 10 will result in a variation in the normal force exerted by each of the roller members 13.

It will be appreciated that since the roller members 13 are located at different distances from the fulcrum 10, any rotation of the lever 8 will result in the roller members 13 exerting differing normal forces on the elongate load bearing member 102 as it passes over the traction sheave 6. This can lead to early deterioration of the elongate load bearing member 102.

A solution to this is outlined in FIG. 13 which illustrates an alternative arrangement to that depicted in FIG. 12. In this example the roller members 13 are mounted on chain links 38 to form a chain. One end of the chain is fixed directly to the clamping lever 8 and the other end of the chain is attached to the clamping lever 8 by means of a pre-tensioned spring 39. Accordingly, each of the roller members 13 will apply the same, uniform normal force to the elongate load bearing member 102 as it passes over the traction sheave 6. It will be appreciated that both ends of the chain can be attached to the lever 8 via pre-tensioned springs 39.

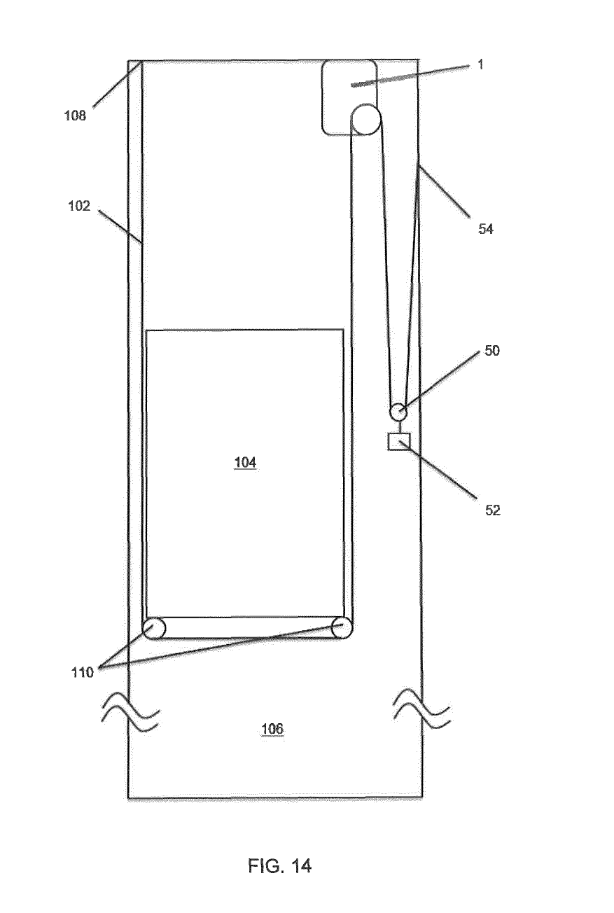

In the previously described embodiments the portion of the elongate load bearing member 102 which is not being used to support the elevator car 104 is stored by being wound upon the reel 24. FIG. 14 illustrates an elevator installation incorporating an alternative method of storing the elongate load bearing member 102. The portion of the elongate load bearing member 102 which is not being used to support the elevator car 104, i.e. the untensioned portion of the elongate load bearing member 102, passes from the elevator drive 1, around a deflecting pulley 50 to which a weight 52 is attached and finally back up to a termination point 54 within the elevator hoistway 106. As the untensioned portion of the elongate load bearing member 102 is drawn into the drive 1 or alternatively fed out from the drive 1, the pulley 50 and the attached weight 52 are raised and lowered within the elevator hoistway 106 accordingly. It should be noted that the weight 52 is not a counterweight in the conventional sense but instead is only of sufficient size so as to draw the untensioned elongate load bearing member 102 downward along the hoistway 106. The pulley 50 and the weight 52 can be accommodated within a U-shaped channel along the hoistway 106.

Belts are becoming more prevalent within the elevator industry as a means for supporting and driving the elevator car though the hoistway. Compared to a conventional circular rope, a rectangular belt having the same cross-sectional area will have a reduced thickness. This allows the elevator designer to select smaller sized components for use in conjunction with the belt and therefore save on material costs and also improve on space efficiency within the elevator installation. Accordingly, the elongate load bearing member can be in the form of a belt as well as conventional elevator ropes.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator drive comprising:
a motor;
a traction sheave driven by the motor for engaging with an elongate load bearing member supporting an elevator car; and
a pressure applicator arranged to exert normal force on the elongate load bearing member towards the traction sheave, wherein one of the traction sheave and the pressure applicator is mounted on a lever rotatable about a fulcrum and is thereby displaceable relative to another of the traction sheave and the pressure applicator, and whereby a tension in the elongate load bearing member biases the lever about the fulcrum when the traction sheave engages the elongate load bearing member.

17. The elevator drive according to claim 16 including a switch monitoring a position of the lever.

18. The elevator drive according to claim 16 wherein the pressure applicator comprises a belt entrained over a first pulley and a second pulley and engaging the elongate load bearing member.

19. The elevator drive according to claim 16 wherein the pressure applicator comprises a plurality of rollers spring biased towards the traction sheave and engaging the elongate load bearing member.

20. The elevator drive according to claim 19 wherein the rollers are mounted on chain links forming a chain and at least one end of the chain is anchored by a spring.

21. The elevator drive according to claim 16 wherein the motor is mounted on the lever.

22. The elevator drive according to claim 21 wherein the tension in the elongate load bearing member biases the traction sheave towards the pressure applicator.

23. The elevator drive according to claim 16 wherein the pressure applicator is mounted on the lever.

24. The elevator drive according to claim 23 including a spring acting on the lever to bias the pressure applicator towards the traction sheave.

25. The elevator drive according to claim 23 wherein the tension in the elongate load bearing member acts on the lever to bias the pressure applicator towards the traction sheave.

26. The elevator drive according to claim 25 including a diverting pulley mounted to the lever and the elongate load bearing member travels over the diverting pulley.

27. The elevator drive according to claim 23 wherein the pressure applicator comprises a belt entrained over a first pulley and a second pulley and wherein at least one of the first pulley and the second pulley is mounted on the lever.

28. A counterweight-less elevator installation comprising:
an elevator car;
an elongate load bearing member supporting the elevator car; and
elevator drive comprising,
a motor,
a traction sheave driven by the motor engaging with the elongate load bearing member, and
a pressure applicator exerting normal force on the elongate load bearing member towards the traction sheave, wherein one of the traction sheave and the pressure applicator is mounted on a lever rotatable about a fulcrum and is thereby displaceable relative to another of the traction sheave and the pressure applicator, and whereby a tension in the elongate load bearing member biases the lever about the fulcrum.

29. A method for driving a counterweight-less elevator comprising the steps of:
driving a traction sheave;
supporting an elevator car on an elongate load bearing member engaging the traction sheave; and
exerting a normal force on a portion of the elongate load bearing member passing over the traction sheave and varying the normal force in accordance with changes in a tension in the elongate load bearing member.

30. The method according to claim 29 including a step of providing a pressure applicator to exert the normal force on the portion of the elongate load bearing member as it engages with the traction sheave.
